(19) United States
(12) Patent Application Publication
(10) Pub. No.: US 2017/0099613 A1
(43) Pub. Date: Apr. 6, 2017

(54) CONTROLLING BACKGROUND DATA TRAFFIC IN A CELLULAR NETWORK

(71) Applicants: Sony Mobile Communications Inc., Tokyo (JP); Sony Corporation, Tokyo (JP)

(72) Inventors: Anders Berggren, Lund (SE); Brian Martin, Farnham (GB)

(21) Appl. No.: 15/255,277

(22) Filed: Sep. 2, 2016

Related U.S. Application Data
(60) Provisional application No. 62/236,551, filed on Oct. 2, 2015.

(51) Int. Cl. H04W 28/02; H04W 8/24

(52) U.S. Cl. CPC H04W 28/0231; H04W 8/245; H04W 88/02

(57) ABSTRACT

Apparatus, systems, and methods provide for the cellular network to indicate preferences for controlling/regulating the background data traffic. Specifically, the network communicates a message to UEs that request that the UEs control background data transmissions. In response to the UEs receiving the message, the UEs reconfigure to control background date transmissions, such as controlling the volume of background data transmissions (e.g., reducing the volume of background data transmissions or the like). In specific embodiments the UE reconfigures by queuing background data and subsequently transmitting the queued background data at time intervals. As a result of such background data traffic control, the network experiences less radio traffic and problems related to cell overloading can be mitigated.

### FIELD OF THE INVENTION

In general, embodiments of the invention relate to cellular network and, more particularly, controlling background data traffic in the cellular network by communicating a message from the network to User Equipment (UE) that requests that the UE controls background data transmissions and, in response to the UE receiving the message, reconfiguring the UE to control background data transmissions.

### BACKGROUND

With the introduction of multitasking operating systems in User Equipment (UE), commonly referred to as cellular devices, most of today's smartphone applications; in particular, social media, cloud and notification service applications, will make frequent network connections involving small amounts of data. Such seemingly always-connected nature results in network “chattiness” may occur when a user actively interacts with an application, but is primarily performed by the application when no direct user interaction is being carried out. Such communications, in which no direct user interaction occurs, are referred to as background data traffic or unattended data traffic. Background data traffic or transmissions occur when the user interface of the UE is inactive, (e.g., the screen/keypad is an inactivate/locked state, a predetermined period of time has lapsed since the UE last received an input from a user, or the like).

In some scenarios in which a large number of cellular network users populate a small area, for example, at a stadium event or the like, background data traffic can be problematic; overloading a cell within the network with less significant radio traffic and, in particular, related Radio Resource Control (RRC) connection setup traffic.

Therefore, a need exists to develop apparatus, systems, methods and the like that provide for controlling the background data traffic, especially in those instances in which the network is experiencing high congestion.

### BRIEF SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatus, systems, computer program products, methods or the like for controlling background data traffic, otherwise referred to as unattended data traffic within a cellular network. Such background data is transmitted when the User Interface (UI) of the User Equipment (UE), commonly referred to as cellular device, is inactive (e.g., when the UE is an idle mode, a power save mode, or the like). As such, the user of the UE is unaware that the background data is being transmitted (i.e., the user has not initiated or otherwise performed an action to cause the background data to be transmitted).

Specifically, embodiments of the present invention provide for the cellular network, specifically, the base stations, commonly referred to as eNBs (Evolved Node B) to communicate a message to UEs that request that the UEs control background data transmissions. In response to the UEs receiving the message, the UEs reconfigure to control background date transmissions. In specific embodiments of the invention, controlling background data transmissions involves controlling the volume of background data transmissions (e.g., reducing the volume of background data transmissions or the like). For example, in specific embodiments the UE reconfigures by queuing background data and subsequently transmitting the queued background data at time intervals (e.g., once every 15 minutes, once every 30 minutes, once every hour, once every two hours or the like). As a result of such background data traffic control, the network experiences less radio traffic and problems related to cell overloading can be mitigated.

A method for controlling background data traffic in a cellular network defines first embodiments of the invention. The method includes receiving, by a UE, a message, communicated from a base station, which requests that the UE controls background data transmissions. In specific embodiments the message may be communicated by the base station in response to the network experiencing congestion. The method further includes, in response to receiving the message, reconfiguring the UE to control background data transmissions. Background data transmissions are defined as data transmissions conducted when the User Interface (UI) of the UE is inactive.

In specific embodiments of the method, reconfiguring the UE further includes reconfiguring the UE to control a volume of background data transmissions, specifically, in certain embodiments, reconfiguring the UE to reduce a volume of background data transmissions.

In other specific embodiments of the method, reconfiguring the UE further includes queuing the background data and transmitting the queued background data at a time interval. In specific embodiments of the method, receiving the message further includes receiving the message that includes a network-determined parameter, which defines the time interval. In other related embodiments, the predetermined interval period is preconfigured in the UE (e.g., defined by standardization, negotiated with service provider (e.g., included in Subscriber Identity Module (SIM)) or the like) or dynamically determined through negotiation between the UE and the network/service provider.

In further specific embodiments of the method, receiving the message further includes, receiving the message that includes a network-determined transmission time window (i.e., the length of the time slot). The transmission time window commences after the time interval and defines a period of time during which queued background data can be transmitted. In other related embodiments of the method, receiving the message further includes, receiving the message that includes a network-determined time slot for transmitting an initial transmission of queued background data. In such embodiments of the method, the network-determined time interval and/or time slot may be determined, by the network, based on at least one of (i) UE Identifier (ID), (ii) System Frame Number (SFN), and/or (iii) random number.

In other specific embodiments of the method, reconfiguring the UE further includes determining, by the UE, a time slot for transmitting the queued background data. In such embodiments of the method, determining, by the UE, the time slot further includes determining by the UE, a time slot for transmitting the queued background data based on at least one of (i) UE Identifier (ID), (ii) System Frame Number (SFN), and/or (iii) random number.

In further specific embodiments of the method, receiving the message further includes receiving the message that requests that the UE controls background data transmissions, wherein the message defines a level of control based on at least one of (i) a priority assigned to types of UEs, (ii) a subscription or access class assigned to the UE, and (iii) one or more applications associated with the background data and reconfiguring the UE based on the level of control. In other embodiments of the method, reconfiguring may include identifying, by the UE, background data rules that define a level of control based on at least one of (i) a priority assigned to types of UEs, (ii) a subscription or access class assigned to the UE.

In still further specific embodiments the method includes, in response to reconfiguring the UE to control background data transmissions, receiving a user input (e.g., an override) that reconfigures the UE to disable control of the background data transmissions or, in other embodiments, receiving a user input that temporarily disables control of the background data transmissions (i.e., allows the user to receive text/SMS (Short Message Service) messages, emails or the like before reverting back to a controlled background data transmission state.

Moreover, in further specific embodiments the method includes, in response to receiving the message, providing, on the UI, a confirmation alert that is configured to allow the user to confirm activation of the reconfiguring prior to reconfiguring the UE to control background data transmissions. In such embodiments the user, as opposed to the network, has control over whether background data transmissions should be controlled or otherwise limited.

A UE apparatus in a cellular network defines second embodiments of the invention. The apparatus includes a computing platform having a memory and a processor device in communication with the memory. In addition, the apparatus includes a background data transmission control application, stored in the memory and executable by the processor. The application is configured to, in response to the UE receiving a network message that requests that the UE controls background data transmissions, reconfigure the UE to control background data transmissions. The background data transmission are defined as data transmissions conducted when the User Interface (UI) of the UE is inactive.

In specific embodiment of the apparatus, the background data transmission control application is further configured to reconfigure the UE to control a volume of background data transmissions, such as reducing the volume of background data transmissions or the like.

In other specific embodiments of the apparatus, the background data transmission control application is further configured to queue the background data and transmit the queued background data at a time interval. In such embodiments of the apparatus, the time interval is either included in the message or preconfigured in the UE.

In other specific embodiments of the apparatus, the background data transmission control application is further configured to determine a time slot for transmitting the queued background data. In such embodiments of the invention, the background data transmission control application may be further configured to determine a time slot based on at least one of (i) UE Identifier (ID), (ii) System Frame Number (SFN), and (iii) random number.

In still further specific embodiments of the apparatus, the background data transmission control application is further configured to, in response to reconfiguring the UE to control background data transmissions, receive a user input that permanently disables (i.e., overrides) or temporarily disables (i.e., allows the UE to receive/send texts/emails or the like) control of the background data transmissions. In other specific embodiments of the apparatus, the background data transmission control application is further configured to, in response to receiving the message, provide, on the UI, a confirmation alert that is configured to allow the user to confirm activation of the reconfiguring prior to reconfiguring the UE to control background data transmissions.

A cellular communication network adapted for controlling background data traffic defines third embodiments of the invention. The system includes a plurality of base stations each including a computing platform having a first memory and a first processing device in communication with the memory. In addition the base stations include a background data control request application that is stored in the first memory and executable by the first processing device. The background data control request application is configured to communicate, via the cellular communication network, a message that requests control of background data transmissions. The system additionally includes one or more User Equipment (UE) apparatus each including a second computer platform having a second memory and a second processing device in communication with the memory. The UE apparatus additionally includes a background data transmission control application that is stored in the second memory and executable by the second processor. The background data transmission control application is configured to receive the message from the base station and, in response to receiving the message, reconfigure the UE to control background data transmissions.

In specific embodiments of the system, the background data transmission control application is further configured to reconfigure the UE to control a volume of background data transmissions.

In other specific embodiments of the system, the background data transmission control application is further configured to queue the background data and transmit the queued background data at a time interval. In related embodiments of the system, the background data control request application is further configured to communicate, via the cellular communication network, a message that requests control of background data transmissions and includes one or more network-determined parameters, which define one or more of one or more of (i) the time interval, (ii) a transmission time window, and (iii) a time slot. In other related embodiments of the system, the time interval is preconfigured in the UE.

In still further specific embodiments of the system, the background data transmission control application is further configured to determine a time slot for transmitting the queued background data based on at least one of (i) UE Identifier (ID), (ii) System Frame Number (SFN), and (iii) random number.

Moreover, in further embodiments of the system, the background data control request application is further configured to communicate the message that requests control of background data transmissions, wherein the message defines a level of control based on at least one of (i) a priority assigned to types of UEs, (ii) a subscription or access class assigned to the UE, and (iii) one or more applications associated with the background data.

Thus, systems, apparatus, methods, and computer program products herein described in detail below provide for controlling background data transmission/traffic in a cellular network. Specifically, the cellular networks communicates a message/indication to UEs that request that the UEs control background data transmissions. In response to the UEs receiving the message, the UEs reconfigure to control background date transmissions, such as controlling the volume of background data transmissions (e.g., reducing the volume of background data transmissions or the like). In specific embodiments the UE reconfigures by queuing background data and subsequently transmitting the queued background data at time intervals. As a result of such background data traffic control, the network experiences less radio traffic and problems related to cell overloading can be mitigated.

### BRIEF DESCRIPTION OF THE DRAWINGS

Having thus described embodiments of the invention in general terms, reference will now be made to the accompanying drawings, where:

FIG. 1 is a schematic diagram of a system for controlling background data transmissions, in accordance with embodiments of the present invention;

FIG. 2 is a block diagram of a system for controlling background data transmissions, in accordance with embodiments of the present invention; and

FIG. 3 is a flow diagram of a method for controlling background data transmissions, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein;

rather, these embodiments are provided so that this disclosure may satisfy applicable legal requirements. Like numbers refer to like elements throughout.

A device may be referred to as a node or user equipment (“UE”). For the purpose of sending or receiving data, the device may connect to a wireless local area network (“WLAN”) or a mobile/cellular communication network (including evolution of 3GPP) LTE releases and 5^{th} Generation (“5G”) LTE releases). Any cellular network described herein may have one or more base stations (“BS”), otherwise referred to “eNB”, and/or access points (“AP”).

As discussed in detail herein, the present invention provides for controlling background data traffic, otherwise referred to as unattended data traffic within a cellular network. Such background data is transmitted when the User Interface (UI) of the User Equipment (UE), commonly referred to as cellular device, is inactive (e.g., when the UE is an idle mode, a power save mode, or the like). As such, the user of the UE is unaware that the background data is being transmitted (i.e., the user has not initiated or otherwise performed an action to cause the background data to be transmitted).

Specifically, embodiments of the present invention provide for the cellular network, specifically, the base stations, commonly referred to as eNBs (Evolved Node B) to communicate a message/indication to UEs that request that the UEs control background data transmissions. In response to the UEs receiving the message, the UEs reconfigure to control background date transmissions. In specific embodiments of the invention, controlling background data transmissions involves controlling the volume of background data transmissions (e.g., reducing the volume of background data transmissions or the like). For example, in specific embodiments the UE reconfigures by queuing background data and subsequently transmitting the queued background data at time intervals (e.g., once every 15 minutes, once every 30 minutes, once every hour, once every two hours or the like). As a result of such background data traffic control, the network experiences less radio traffic and problems related to cell overloading can be mitigated.

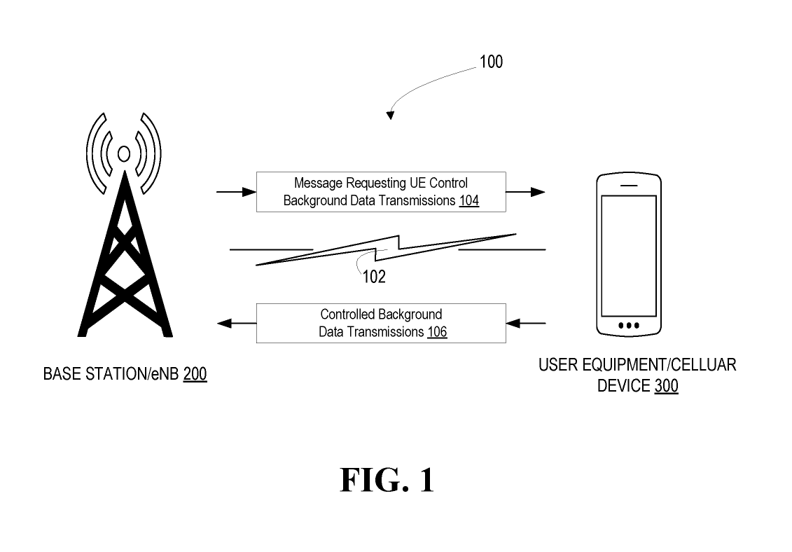

Referring to FIG. 1 a block diagram is presented of a system 100 for controlling background data transmissions, in accordance with embodiments of the present invention. The system includes one or more base stations/eNB 200 and one or more User Equipment (UE)/cellular devices 300. For the sake of clarity, FIG. 1 depicts a single base station/eNB 200 and a single UE/cellular device 300, although system 100 may comprise multiple base stations 200 and multiple UE 300. Base station 200 is configured to transmit, over cellular network 102 a message/indication 104, which requests that the UE control background data transmissions. In specific embodiments of the invention, controlling background data transmissions comprises controlling the volume of background data transmissions, and, specifically, reducing or otherwise limiting, without disabling, the volume of background data transmissions.

In response to receiving the message/indication 104, UE 300 reconfigures the UE resulting in controlled background data transmissions 106. In specific embodiments of the invention, the UE reconfigures by queuing background data and, subsequently transmitting the queued background data at predetermined intervals. The predetermined intervals, which typically range from about 15 minutes to about 180 minutes (i.e., 3 hours) may be dynamically defined by the network (i.e., included in the message/indication 104 or the like), or preconfigured/stored in the UE (i.e., standardized by specification or negotiated by the service provider). By controlling background data transmission, such as by queuing background data and subsequently transmitting the queued background data at time intervals, the present invention mitigates problems associated with less significant radio traffic (i.e., background data) overloading cells within the network.

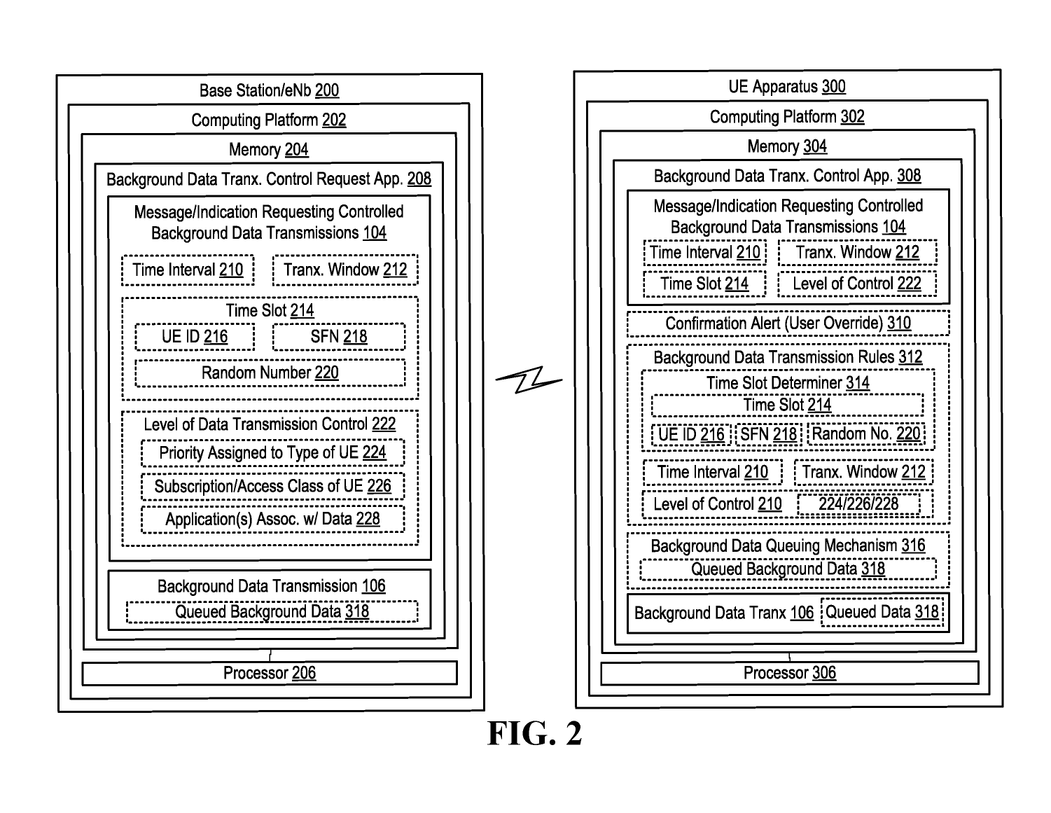

Referring to FIG. 2 shown is a block diagram of a system 100 for controlling background data traffic in a cellular network, in accordance with embodiments of the present invention. As previously noted in FIG. 1, system 100 includes one or more base stations 200 and one or more UE 300.

The base station/eNB 200 includes a computing platform 202 having a memory 204 and a processor 206 in communication with the memory 204. The memory 208 stores background data transmission control request application 208 that is configured to generate and initiate transmission of a message/indication 104 requesting controlled background data transmissions. In addition, message/indication 104 may include network-determined parameters, such as a parameter that defines the time interval 210 and the transmission window 212. The time interval 210 is the time between background data transmissions and the transmission window 212 is the time or duration during which background data may be transmitted. For example, a typical time interval 210 may be between about 15 minutes and 180 minutes and a typical transmission window may be about 1 minute. In specific embodiments of the invention, the network may determine the time interval 210 and/or the transmission window 212 based on the level of data traffic existing in the cell. In other embodiments of the invention, the time interval 210 and/or 222 assigned to a UE may be determined based on a level of data transmission control 222. The level of data transmission (e.g., high priority, medium priority, low priority or the like) may be based on the type of UE 224 (e.g., MTC (Machine Type Communication vs CIoT (Cognizant Internet of Things vs convention Mobile Terminal/Device and the like), based on subscription or access class 226 assigned to the UE or user and/or the application(s) 228. associated with the background data being transmitted by the UE. As such, the network-determined parameters may be generic parameters applicable to one, and in some instances all devices currently communicating with the cell or the network-determined parameters may be UE-specific or user-specific, based on priority assigned to the type of UE 224, subscription/access class 226 associated with UE/user and/or applications 228 associated with the background data.

Additionally, the message/indication 104 may include a time slot 214, otherwise referred to transmission occasion that is specific to the UE. The time slot 214 is the initial time for opening a transmission window 212. For example, if the time slot 214 is determined to be x time, the initial transmission window will open x time after reconfiguring the UE for controlled background data transmission and will remain open for transmissions for the duration of the defined transmission window. Once the transmission window 212 has expired, the next time slot will be defined by the time interval 210 (e.g., 15 minutes from the end of the transmission window 212, 30 minutes from the end of the transmission 212 or the like). The time slot 214 and/or time interval 210 may be determined based on one or more of UE-Identifier 216, System Frame Number (SFN) 218 and/or a Random Number 218. For example, in specific embodiments the UE may transmit background data at every SFN 218=(UE-ID 216 mod 128)×a duration parameter). By assigning a unique time slot to each of the UE in the network, the time at which different UEs transmit background data or attempt to access will differ, even though the time intervals 210 and/or transmission windows 212 may be the same, thereby further reducing the number of simultaneous transmissions or attempts to access the network which results in further reduction in the overall congestion within the network.

In response to transmitting the messages/indications 104 to the UEs and the UEs reconfiguring to allow for controlled background data transmissions, the base station/eNB 200 will receive controlled background data transmissions 106 for the UEs, which according to specific embodiments of the invention may comprise queued background data 318.

In addition, it should evident that message/indication 104 may be configured to comprise more than one message, such that one message includes the indication of the request for controlled background data transmissions and, subsequent messages include one or more network-determined parameters that define timing parameters or the like.

The UE apparatus 300 may be a convention mobile terminal/device, a CIoT device, a MTC device or any other apparatus/device capable of communicating with the cellular network 102 The UE 300 includes a computing platform 302 having a memory 304 and a processor 306 in communication with the memory 304. The memory 304 stores background data transmission control application 308 that is configured to, in response to receiving message/indication 104, reconfigure the UE 300 to control background data transmissions.

In specific embodiments of the invention, as previously discussed reconfiguring the UE to provide for controlled background data transmission is accomplished by queuing the background data and subsequently transmitting the queued background date at time intervals. In such embodiments, background data transmission control application includes background data queuing mechanism 316 that is configured to queue background data 318 for subsequent transmissions at time intervals 210. In specific UEs, such a feature/option may be available to the user as a means of improving power consumption. However, if the device has entered a power save mode or another mode which prohibits background data transmissions, the queuing of background data feature/option is turned off or otherwise disabled. The present invention serves to override the disablement of the queuing of background data feature/option by automatically enabling the feature in response to receiving the message/indication 104 from the network.

In specific embodiments of the invention, the background data transmission control application 308 may be configured to provide, on the User Interface of the UE, a confirmation alert 310 or the like that is configured to allow the user to acquiesce (i.e., provide an input or the like) to give control of the background data transmission to the UE or override the automated control of background data transmission by the UE. In such embodiments of the invention, the user, as opposed to the network, makes the decision as to whether control over the background data transmissions can be activated (i.e., as opposed to automatically activating the queuing of background data feature/option the user is provided with an option as to whether the feature option should be activated).

As previously noted, in specific embodiments of the invention, the message/indication 104 may be configured to include network-determined parameters, such as time interval 210, transmission window 212 and/or time slot 214 or the message/indication 104 may include the level of control 222.

In those embodiments in which the message/indication 104 is configured such that one or more of the background transmission parameters are not determined by the network (i.e., not include in the message/indication 104), background data transmission rules 312 may be applied to determine requisite parameters for controlling background data transmissions 314. For example, in those embodiments in which the network does not determine time slot 214, the UE may implement time slot determiner 314 to determine or otherwise identify the time 214. Similar to embodiments in which the time slot 214 is determined by the network, time slot 214 and/or time interval 210 may be determined by time slot determiner 314 based on one or more of UE-ID 216, SFN 218 and/or a random number 220.

Moreover, in those embodiments in which the network does identify the time interval 210 or the transmission window 212, these parameters may be stored in UE memory based or standardization or service provider/operator-specified.

In addition, background data transmission rules 312 may rely on level of data transmission control 210 in determining the level and/or priority provided to the UE in terms of controlling background data transmission. Similar to applying the levels of control 22 at the network level, the UE may determine level of control based on priority assigned to the type of UE 224, subscription/access control granted to the UE and/or user, and/or the applications associated with the background data being transmitted. For example, a UE having a highest priority due to type of UE, and/or subscription/access control may be granted less of a time interval 210 (i.e., more frequent times to transmit background data) and/or a longer transmission window 212 or, in further embodiments, highest priority UE's may allotted to always attend/attempt background data transmissions (i.e., no queuing of background data). Lowest priority UEs due to type of UE and/or subscription/access control may be granted more a longer time interval 210 (i.e., less frequent times to transmit background data) and/or shorter transmission windows 212 or, in other embodiments, lowest priority UE's may be prohibited from transmitting background data for a prolonged period of time. While medium priority UEs may have periodicity (i.e., time interval and/or transmission window 212 in a range somewhere between that afforded to the highest priority UEs and the lowest priority UEs.

In other embodiments of the invention in which applications associated with the background data are granted different priority/level of data transmission control, the periodicity may vary dynamically depending on which applications are requesting to transmit data and the priority/level of control afforded to those applications.

In additional embodiments of the invention, the background data transmission control application 308 may be configured with an override option that allows the user to override/disable the automated control of the background data transmissions. In such embodiments of the invention, activation of the override option by the user will revert the UE to the previous or default background data transmission state (e.g., uncontrolled/unlimited background data transmissions, prohibited/disabled background data transmissions or the like).

In still further embodiments of the invention, the background data transmission application 308 may be configured with a temporary override option that allows the user to user to perform a designated action, such as swiping the touch screen or the like, to temporarily deactivate control over the background data transmissions, such temporary deactivation, which may last for a predetermined time period (e.g., 10-30 seconds) allows for the receipt/transmission of texts/SMS messages, emails and the like. After the temporary deactivation period lapses, the UE reverts back to the controlled background data transmission state in which it previously resided.

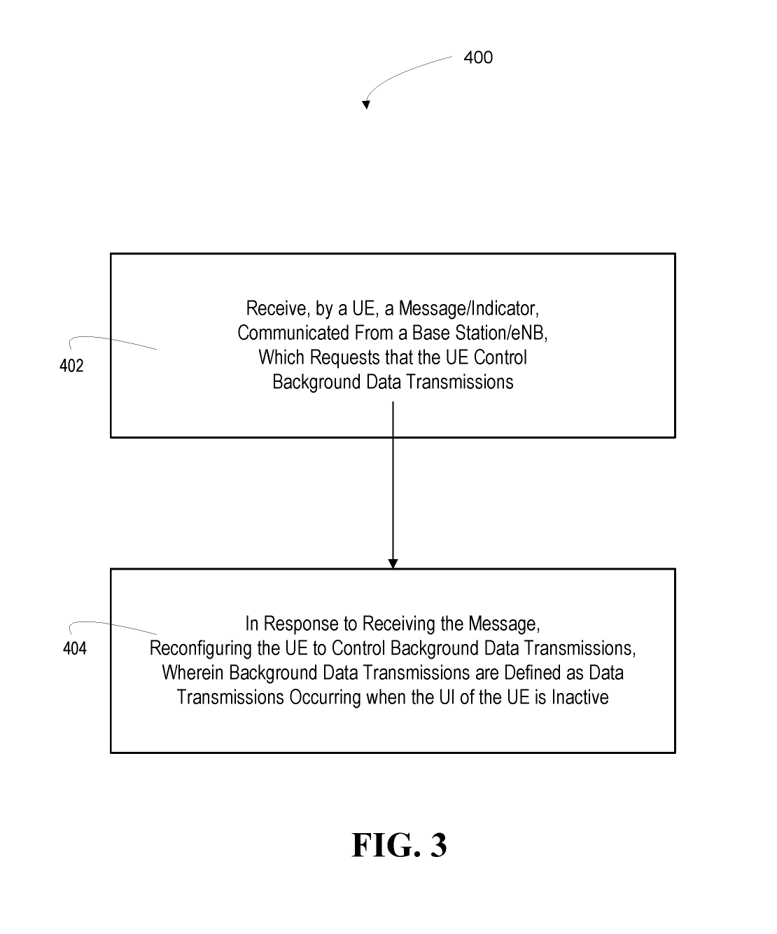

Referring to FIG. 3 a flow diagram is presented of a method 400 for controlling background data traffic in a cellular network, in accordance with embodiments of the present invention. At Event 402, the UE receives a message/indication from a base station/eNB that requests that the UE controls background data transmissions. In specific embodiments of the method, the message/indication may include network-determined parameters associated with the control of the background data transmissions, such as parameters that define time interval, transmission window and/or time slot. Moreover, the message/indication may include the level of control based on UE type, subscription/access class, or the like.

At Event 404, in response to the UE receiving the message/indication requesting that the UE control background data transmissions, the UE reconfigures to control background data transmissions. In specific embodiments of the invention, the UE is granted control over the volume of background data transmission, such as reducing the volume of background data transmissions. In specific embodiments, reducing the volume of background data transmissions entails queuing the background data and, subsequently transmitting the background data at predetermined intervals, which are determined by the network or preconfigured on the UE.

Thus, systems, apparatus, methods, computer program products and the like described above provide for controlling background data transmission/traffic in a cellular network. Specifically, the cellular networks communicates a message/indication to UEs that request that the UEs control background data transmissions. In response to the UEs receiving the message, the UEs reconfigure to control background date transmissions, such as controlling the volume of background data transmissions (e.g., reducing the volume of background data transmissions or the like). In specific embodiments the UE reconfigures by queuing background data and subsequently transmitting the queued background data at time intervals. As a result of such background data traffic control, the network experiences less radio traffic and problems related to cell overloading can be mitigated.

Each processor described herein generally includes circuitry for implementing audio, visual, and/or logic functions. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory.

Each memory may include any computer-readable medium. For example, memory may include volatile memory, such as volatile random access memory (“RAM”) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

The various features described with respect to any embodiments described herein are applicable to any of the other embodiments described herein. As used herein, the terms data and information may be used interchangeably. Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (“ROM”), an erasable programmable read-only memory (“EPROM” or Flash memory), a compact disc read-only memory (“CD-ROM”), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable information processing apparatus in order to produce a particular machine, such that the one or more computer-executable program code portions, which execute via the processor of the computer and/or other programmable information processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable information processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable information processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A method for controlling background data traffic in a cellular network, the method comprising:
receiving, by a User Equipment (UE), a message, communicated from a base station, that requests that the UE controls background data transmissions; and
in response to receiving the message, reconfiguring the UE to control background data transmissions,
wherein background data transmissions are data transmissions conducted when the User Interface (UI) of the UE is inactive.

2. The method of claim 1, wherein reconfiguring the UE further comprises reconfiguring the UE to control a volume of background data transmissions.

3. The method of claim 1, wherein reconfiguring the UE further comprises reconfiguring the UE to reduce a volume of background data transmissions.

4. The method of claim 1, wherein reconfiguring the UE further comprises queuing the background data and transmitting the queued background data at a time interval.

5. The method of claim 4, wherein receiving the message further comprises, receiving, by the UE, the message, communicated from the base station, that requests that the UE controls background data transmissions and includes a network-determined parameter, which defines the time interval.

6. The method of claim 5, wherein the network-determined parameter which defines the time interval for transmitting an initial transmission of queued background data is determined, by the network, based on at least one of (i) UE Identifier (ID), (ii) System Frame Number (SFN), and (iii) random number.

7. The method of claim 4, wherein reconfiguring the UE further comprises queuing the background data and transmitting the queued background data at the time interval, wherein the time interval is preconfigured in the UE.

8. The method of claim 4, wherein reconfiguring the UE further comprises dynamically negotiating with the network to identify the time interval.

9. The method of claim 4, wherein receiving the message further comprises, receiving, by the UE, the message, communicated from the base station, that requests that the UE controls background data transmissions and includes a network-determined transmission time window that commences after the time interval and defines a period of time during which queued background data can be transmitted.

10. The method of claim 4, wherein reconfiguring the UE further comprises determining, by the UE, a time slot for transmitting the queued background data.

11. The method of claim 10, wherein determining, by the UE, the time slot further comprises determining by the UE, a duration of the time slot for transmitting the queued background data based on at least one of (i) UE Identifier (ID), (ii) System Frame Number (SFN), and (iii) random number.

12. The method of claim 1, wherein the message is communicated from the base station in response to the network experiencing congestion.

13. The method of claim 1, wherein receiving the message further comprises receiving the message that requests that the UE controls background data transmissions, wherein the message defines a level of control based on at least one of (i) a priority assigned to types of UEs, (ii) a subscription or access class assigned to the UE, and (iii) one or more applications associated with the background data.

14. The method of claim 1, further comprising in response to reconfiguring the UE to control background data transmissions, receiving a user input that reconfigures the UE to disable control of the background data transmissions.

15. The method of claim 1, further comprising in response to reconfiguring the UE to control background data transmissions, receiving a user input that temporarily disables control of the background data transmissions.

16. The method of claim 1, further comprising in response to receiving the message, providing on the user interface a confirmation alert that is configured to allow the user to confirm activation of the reconfiguring prior to reconfiguring the UE to control background data transmissions.

17. A User Equipment (UE) apparatus in a cellular network, the apparatus comprising:
a computing platform having a memory and a processor device in communication with the memory; and
a background data transmission control application, stored in the memory, executable by the processor and configured to:
in response to the UE receiving a network message that requests that the UE controls background data transmissions, reconfigure the UE to control background data transmissions,
wherein background data transmissions are data transmissions conducted when the User Interface (UI) of the UE is inactive.

18. The apparatus of claim 17, wherein the background data transmission control application is further configured to reconfigure the UE to control a volume of background data transmissions.

19. The apparatus of claim 17, wherein the background data transmission control application is further configured to queue the background data and transmit the queued background data at a time interval, wherein the time interval is either included in the message, preconfigured in the UE or dynamically negotiated with the network.

20. The apparatus of claim 17, wherein the background data transmission control application is further configured to determine a time slot for transmitting the queued background data.

21. The apparatus of claim 17, wherein the background data transmission control application is further configured to determine a duration of the time slot based on at least one of (i) UE Identifier (ID), (ii) System Frame Number (SFN), and (iii) random number.

22. The apparatus of claim 17, wherein the background data transmission control application is further configured to, in response to reconfiguring the UE to control background data transmissions, receive a user input that permanently disable or temporarily disables control of the background data transmissions.

23. The apparatus of claim 17, wherein the background data transmission control application is further configured to, in response to receiving the message, provide, on the UI, a confirmation alert that is configured to allow the user to confirm activation of the reconfiguring prior to reconfiguring the UE to control background data transmissions.

24. A cellular communication network adapted for controlling background data traffic, the system comprising:
a plurality of base stations including a computing platform having a first memory and a first processing device in communication with the memory and a background data control request application stored in the first memory, executable by the first processing device and configured to communicate, via the cellular communication network, a message that requests control of background data transmissions; and
one or more User Equipment (UE) apparatus having a second memory and a second processing device in communication with the memory and a background data transmission control application, stored in the second memory, executable by the second processor and configured to receive the message from the base station and, in response to receiving the message, reconfigure the UE to control background data transmissions,
wherein background data transmissions are data transmissions conducted when the User Interface (UI) of the UE is inactive

25. The system of claim 24, wherein the background data transmission control application is further configured to reconfigure the UE to control a volume of background data transmissions.

26. The system of claim 24, wherein the background data transmission control application is further configured to queue the background data and transmit the queued background data at a time interval.

27. The system of claim 26, wherein the background data control request application is further configured to communicate, via the cellular communication network, a message that requests control of background data transmissions and includes one or more network-determined parameters, which define one or more of one or more of (i) the time interval, (ii) a transmission time window, and (iii) a time slot.

28. The system of claim 26, wherein the background data transmission control application is further configured to queue the background data and transmit the queued background data at a time interval, wherein the time interval is one of preconfigured in the UE or dynamically negotiated between the UE and the network.

29. The system of claim 26, wherein the background data transmission control application is further configured to determine a duration of a time slot for transmitting the queued background data based on at least one of (i) UE Identifier (ID), (ii) System Frame Number (SFN), and (iii) random number.

30. The system of claim 24, wherein the background data control request application is further configured to communicate the message that requests control of background data transmissions, wherein the message defines a level of control based on at least one of (i) a priority assigned to types of UEs, (ii) a subscription or access class assigned to the UE, and (iii) one or more applications associated with the background data.
